(19) United States
(12) Patent Application Publication
(10) Pub. No.: US 2023/0234332 A1
(43) Pub. Date: Jul. 27, 2023

(54) SHRINK SLEEVE LABEL WITH PRE-APPLIED SECONDARY LABEL

(71) Applicant: Multi-Color Corporation, Batavia, OH (US)

(72) Inventors: Patrick A. Young, Appleton, WI (US); Dimitri Stamatiou, Green Bay, WI (US); Daniel R. Ray, Algoma, WI (US)

(21) Appl. No.: 18/159,474

(22) Filed: Jan. 25, 2023

Related U.S. Application Data
(60) Provisional application No. 63/267,200, filed on Jan. 27, 2022.

(51) Int. Cl. B32B 7/028; B32B 7/06; B32B 7/12; B32B 27/10

(52) U.S. Cl. CPC B32B 7/028; B32B 7/06; B32B 7/12; B32B 27/10; B32B 2307/30; B32B 2519/00

(57) ABSTRACT

A shrink sleeve label is provided. Broadly, the shrink sleeve label includes an unshrunken shrink film and a varnish applied to the shrink film. The varnish is applied to the shrink film in an application area to reduce shrinking of the shrink film in the area where the varnish is applied. Additionally, the shrink sleeve label includes a secondary label that is applied to a surface of the shrink film. Further, a method of manufacturing a shrink sleeve label is provided. Broadly, the method includes providing a shrink film and seaming the shrink film into a tubular shape. Additionally, the method includes providing a secondary label and applying the secondary label to the shrink film. The secondary label is applied to the shrink film before the shrink film is applied to an article.

### RELATED APPLICATION

This application claims the benefit of the filing date of U.S. Patent Application Ser. No. 63/267,200, filed Jan. 27, 2022, the disclosure of which is incorporated by reference herein in its entirety.

### TECHNICAL FIELD

This application relates generally to shrink sleeve labels, and, more particularly, to shrink sleeve labels including a secondary label.

### BACKGROUND

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Shrink labeling involves shrinking a film to wrap an article within the film. Indicia such as graphics (e.g., pictures, logos) and/or text, for example, may be printed on the film to provide label information. After the indicia is/are printed on the film, the films are seamed thereby forming a tubular shrink sleeve. Printed rolls or individually cut shrink sleeve labels are then packaged and delivered to a particular (customer) location where each of the shrink sleeve labels can be applied to an article. Application of the shrink sleeve label to an article is generally accomplished through the application of heat to the shrink sleeve label. As the film is heated the film shrinks snugly around the article.

However, the shrink sleeve label may be insufficient for providing all desired label information. For example, the printable surface area of the label may be too small to allow for all of the desired label information to be displayed. Thus, one may desire to add a secondary label such as an extended content label or game or coupon piece, for example, to the shrink sleeve label.

Presently, the process of constructing a shrink sleeve label with an accompanying secondary label (e.g., extended content label, coupon, game piece, etc.) is often accomplished by a two-step process. The two-step process includes first applying (e.g., shrinking) the shrink sleeve label to the article and, second, affixing a separate secondary label to the already-applied shrink sleeve label on the article. This two-step application process is inefficient and invites the additional monetary and time expense of an extra step in the application process.

Accordingly, it would be desirable to provide a shrink sleeve label including a secondary label that avoids, alleviates, or otherwise minimizes the various drawbacks or shortcomings of existing shrink sleeve labels including a secondary label.

### SUMMARY

Certain exemplary aspects of the invention are set forth below. It should be understood that these aspects are presented merely to provide the reader with a brief summary of certain forms the invention might take and that these aspects are not intended to limit the scope of the invention.

In a first set of embodiments of the invention, a shrink sleeve label is provided. The shrink sleeve label includes an unshrunken shrink film and a varnish applied to the shrink film. The varnish is applied in an application area to reduce shrinking of the shrink film in the application area. The shrink sleeve label also includes a secondary label. The secondary label is applied to a surface of the shrink film.

In one embodiment, the secondary label may be applied to the shrink film in the application area. Additionally, the application area may be larger in at least one dimension than the secondary label. Further, the application area may be larger in at least two dimensions than the secondary label.

In another embodiment, the secondary label may be a standard label. Alternatively, the secondary label may be a removable coupon label. Further alternatively, the secondary label may be an extended content label. The extended content label may include multiple panels. Additionally, the extended content label may be resealable.

In yet another embodiment the shrink film may be clear. Alternatively, the shrink film may be non-clear.

In another set of embodiments of the invention, a method of manufacturing a shrink sleeve label is provided. The method includes providing a shrink film and seaming the shrink film into a tubular shape. Additionally, the method includes providing a secondary label and applying the secondary label to the shrink film. Further, the secondary label is applied to the shrink film before the shrink film is applied to an article.

In one embodiment, the method may further include applying a varnish to the shrink film in an application area. The varnish may be configured to prevent shrinking of the shrink sleeve label. Additionally, the varnish may be applied to the shrink film before the shrink film is applied to an article. The varnish may be applied by solid spot sprint. Alternatively, the varnish may be applied by feathered edge spot print. Further alternatively, the varnish may be applied by patterned spot print.

In another embodiment, the secondary label may be applied to the shrink film before the step of seaming. Alternatively, the secondary label may be applied to the shrink film during the step of seaming. Further alternatively, the secondary label may be applied to the shrink film after the step of seaming.

### BRIEF DESCRIPTION OF THE DRAWINGS

The accompanying drawings, which are incorporated in and constitute a part of this specification, illustrate embodiments of the invention and, together with the Detailed Description given below, serve to explain the invention.

FIG. 1 is a perspective view of a shrink sleeve label including a pre-applied secondary label in accordance with principles of the present invention applied to an article.

FIG. 2 is a front view of a blank of a shrink film for forming the shrink sleeve label of FIG. 1, prior to seaming.

FIG. 3A is a front view of an embodiment of a varnish application in accordance with principles of the present invention.

FIG. 3B is a front view of an alternative embodiment of the varnish application of FIG. 3A.

FIG. 3C is a front view of a further alternative embodiment of the varnish application of FIG. 3A.

FIG. 4A is a front view of a secondary label prior to being applied to the shrink film of FIG. 2.

FIG. 4B is a rear view of the secondary label of FIG. 4A.

FIG. 4C is a top view of the secondary label of FIG. 4A.

FIG. 5 is a perspective view of a shrink sleeve label, including a secondary label, of FIG. 1, prior to being applied to an article.

FIG. 6 is a front view of a series of shrink sleeve labels, including secondary labels, of FIG. 1.

### DETAILED DESCRIPTION OF THE INVENTION

The exemplary embodiments described herein are provided for illustrative purposes and are not limiting. Other exemplary embodiments are possible, and modifications may be made to the exemplary embodiments within the scope of the present disclosure. Therefore, this Detailed Description is not meant to limit the scope of the present disclosure.

As described above, there presently are drawbacks or shortcomings of existing shrink sleeve labels including a secondary label. Particularly, the application of a secondary label after applying the shrink sleeve label to an article suffers the drawback of extra expense and requires the extra step, on the part of a customer (as used herein ‘customer’ is intended to mean the entity that purchases the shrink sleeve label from a manufacturer and/or the entity that applies the shrink sleeve label to an article), of applying the secondary label to the shrink sleeve label after applying the shrink sleeve label to an article. In one aspect, the present invention avoids, alleviates, or otherwise minimizes these drawbacks or shortcomings by providing a shrink sleeve label including a pre-applied secondary label.

Referring now to the Figures, embodiments of a shrink sleeve label with a pre-applied secondary label (or portions thereof) in accordance with principles of the present invention are shown in detail. One embodiment of the shrink sleeve label 10 generally includes a shrink film 12 with overprint varnish 14 applied thereon. A secondary label 16 is affixed a top the overprint varnish 14 prior to the shrink film 12 being applied to an article 18. Advantageously, the described shrink sleeve label 10 with pre-applied secondary label 16 provides for a single step application process by a customer. Instead of the industry standard two-step application process, whereby a customer must first apply a shrink film to an article and then apply a secondary label to the shrink film already on the article, the described shrink sleeve label 10 with a pre-applied secondary label 16 provides a customer with a more efficient one-step application process. The customer is provided with a shrink sleeve label 10 with a pre-applied secondary label 16 and needs only to apply the shrink sleeve label 10 (with the pre-applied secondary label 16) to the article 18. No intermediate step (on the part of the customer) of applying a secondary label 16 is necessary. Other advantages and technical effects of the embodiments of this invention will become evident to one skilled in the art from the following description.

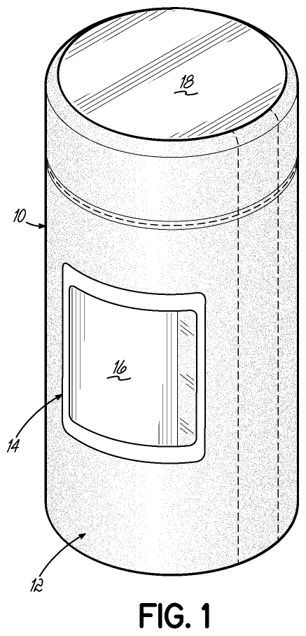

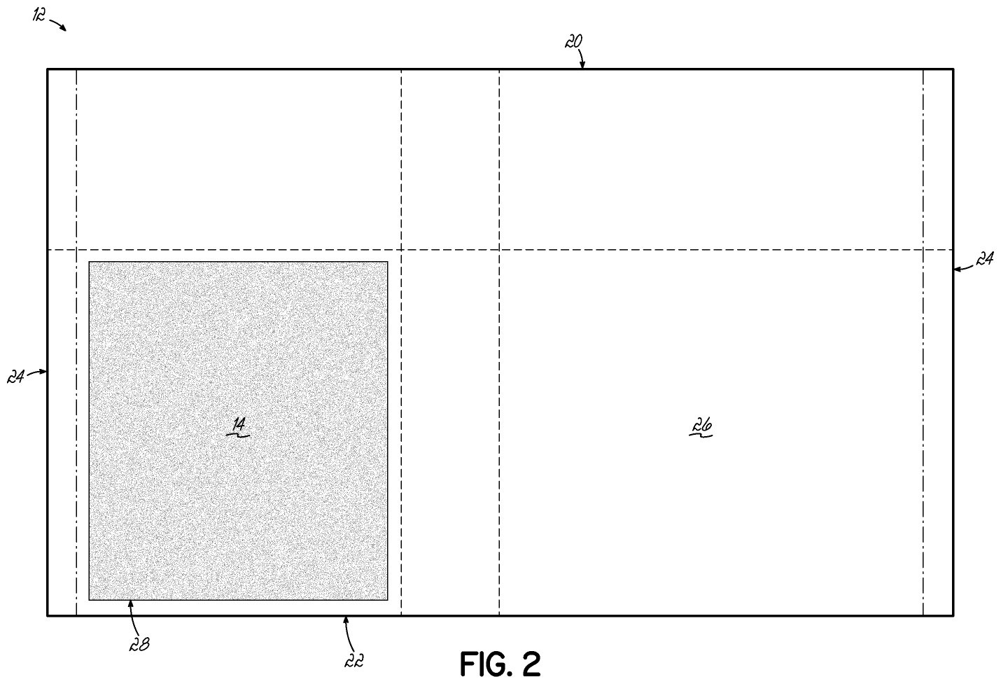

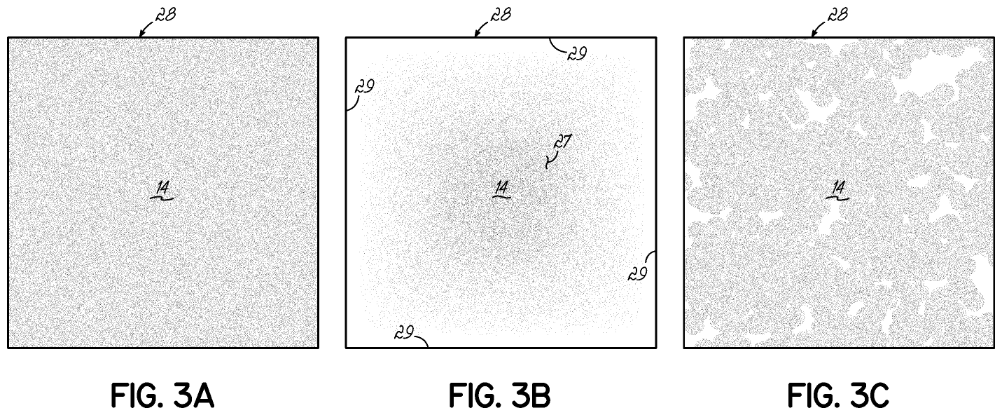

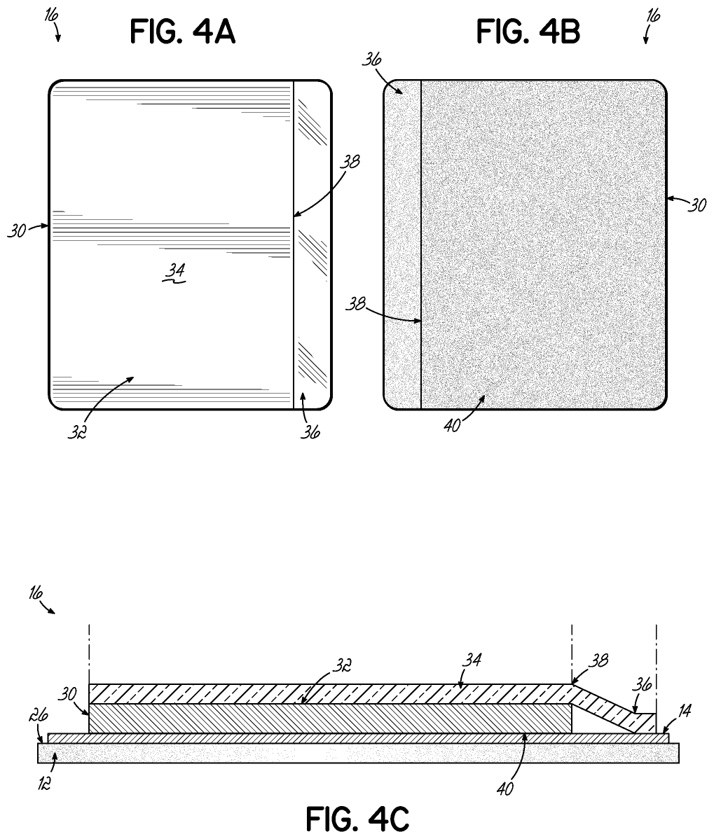

Beginning with reference to FIG. 1, an embodiment of the shrink sleeve label 10 with a pre-applied secondary label 16 is shown as applied to an article 18. The shrink film 12 (see FIG. 2 and description thereof), overprint varnish 14 (see FIGS. 2-3C and description thereof), and the secondary label 16 (see FIG. 4A-4C and description thereof) are described in greater detail below. In the embodiment depicted in FIG. 1, the article 18 is a two-piece container. However, it is to be understood that the article 18 could take on forms other than a two-piece container. In an alternative embodiment, the article 18 could be of unitary construction, for example.

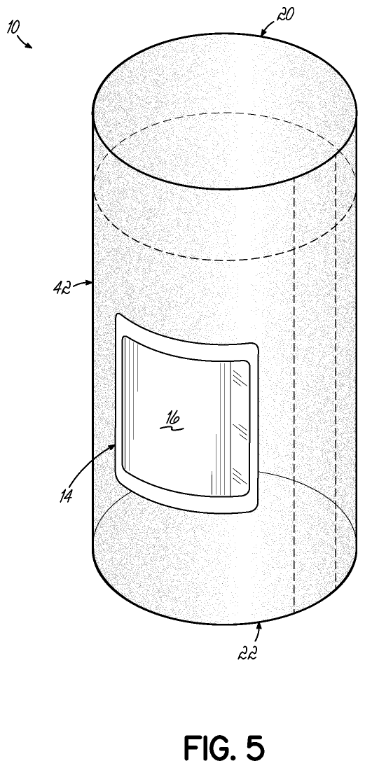

Described at a high level, the shrink sleeve label 10 is constructed and applied as follows. Overprint varnish 14 is applied to the shrink film 12 during an initial printing process. Subsequently, the secondary label 16 is applied to the shrink film 12 and the shrink film 12 is trimmed, glued or seamed, and cut into a loose tubular shape (see FIG. 5). The shrink film 12 is then positioned over the article 18 and the shrink film 12 is heated or steamed. The application of heat or steam shrinks the shrink film 12 to the article 18, thereby covering and sealing the article 18. Alternatively, shrinking of the film 12 may occur during the cooling of a heated or steamed film 12.

Referring now to FIG. 2, the Figure shows a blank of a shrink film 12 before the secondary label 16 has been applied to the shrink film 12. The shrink film 12 is bound at the top by an upper edge 20, at the bottom by a lower edge 22, and one the sides by two lateral edges 24. In the illustrated embodiment, the shrink film 12 is a raw clear film with no adhesive. Particularly, the shrink film 12 may be a clear or white thin film. During an initial press print process, content or label information (e.g., text, graphics, etc.) is printed on the film 12. If a clear film is used, the content may be printed on either side of the film 12—that is, the side of film 12 facing towards or away from the article 18. If a white (or otherwise non-clear) film is used, the content is printed on the side of the film 12 facing away from the article 18. It is to be understood that the construction, composition, and material of the shrink film 12 may vary. For example, the shrink film 12 chosen for a particular application may depend on the shrink properties of the film 12, the barrier properties of the film 12, sustainability concerns, the required amount of label shrink, the product fill within the article 18, customer processing, as well as the size, shape, and/or material of the article 18.

The depicted shrink film 12 includes an application of overprint varnish 14 on a surface 26 of the shrink film 12. The overprint varnish 14 may be of water-based, solvent, or UV chemistry, for example. Further, the varnish 14 may be UV or LED cured, for example. The overprint varnish 14 is applied to the shrink film 12 during an initial press print process when content or label information (e.g., text, graphics, etc.) is printed on the shrink film 12. Particularly, the varnish 14 is applied to the surface 26 of the film 12 facing away from the article 18 and is applied to the film in-line as the content or label information is applied to the film 12. However, it is to be understood that the overprint varnish 14 could alternatively be applied to the shrink film 12. The overprint varnish 14 serves to prevent the shrink film 12 from shrinking in the area where the varnish 14 is applied when heat or steam, for example, is introduced to the shrink film 12. The secondary label 16 is to be affixed to the shrink film 12 in the same area that the varnish 14 is applied to the shrink film 12. In this way, the application of the varnish 14 serves to prevent the shrink film 12 from shrinking in the area around the secondary label 16. Without the varnish 14, the shrink film 12 may pucker or otherwise wrinkle, for example, around the edges of the applied secondary label 16. Such is aesthetically undesirable and could result in the connection between the secondary label 16 and the shrink film 12 being weaker than intended.

With continued reference to FIG. 2, in an alternative embodiment, the varnish 14 may be applied to the shrink film 12 except in the area where the secondary label 16 is to be applied. In other words, varnish 14 could be applied to substantially the entire surface 26 of the shrink film 12, except for the area where the secondary label 16 is to be attached. In such an embodiment, the shrink film 12 would shrink in the area around the secondary label 16, but not in the area where the secondary label 16 is applied. Because the varnish 14 is applied to other portions of the shrink film 12, the shrink of the film 12 would be controlled as to not cause issues of undesirable wrinkling, puckering, or similar. In a further alternative embodiment, application of the varnish 14 may be unnecessary. For example, the shrink film 12 and the article 18 may be sized such that the shrink film 12 does not have to shrink much to snugly fit the article 18. Thus, worries of wrinkling, puckering, or similar would be minimal due to the small amount of shrink the film 12 would undergo. Generally, how or if the varnish 14 is applied to the shrink film 12 is determined by a number of variables including, but not limited to, adhesion, properties of the article 18, and/or the shrink percentage of the film 12.

Referring now to FIGS. 3A-3C, the Figures show embodiments of varnish 14 application as would be applied to a shrink film 12. Application of the varnish 14 to the shrink film 12 will vary depending on a number of factors. Generally, the varnish 14 application area 28 will extend approximately 0.125″ beyond the edges (bounds) of the secondary label 16 in all directions. However, varnish 14 application may change depending on the customer shrink process, the material of the shrink film 12, the construction and position of the secondary label 16 on the shrink film 12, the size and shape of the article 18 the film 12 is to be applied to, the adhesive to film 12 transition, as well as the environment (e.g., heat, moisture, dwell time, etc.) in which the article 18 with the applied shrink sleeve label 10 with a pre-applied secondary label 16 is to be stored, for example. Further, it is to be understood that varnish 14 could be applied to the shrink film 12 in additional ways not depicted in FIGS. 3A-3C. For example, the varnish 14 could alternatively or additionally be applied to the shrink film 12 in a tinted or checked manner.

In FIG. 3A, varnish 14 is applied to an application area 28 by solid spot print. The entire area to which varnish 14 is applied (i.e., the application area 28) has a substantially even coating of varnish 14. Such may be desirable if the secondary label 16 to be applied to the shrink film 12 is sizeable (in comparison to other types of secondary labels 16). For example, this varnish 14 application may be appropriate for an extended content label with a large overall size or for an extended content label with a substantial thickness.

In FIG. 3B, varnish 14 is applied to an application area 28 in a feathered edge spot print. In this application, the varnish 14 is applied more heavily near a center 27 of the application area 28 and more lightly near the edges 29 of the application area 28. Such may be desirable if the secondary label 16 to be applied to the shrink film 12 will not occupy the entire area 28 to which varnish 14 is applied. For example, the secondary label 16 may be a game piece that is located centrally within and sized smaller than the area 28 to which varnish 14 is applied. In such a case, it would be unnecessary for as much varnish 14 to be applied near the edges 29 of the application area 28 as is applied closer to the center 27 of the application area 28.

In FIG. 3C, varnish 14 is applied in a patterned spot print to the application area 28. Varnish 14 could be applied in a patterned spot print to the shrink film 12 in a pattern similar or dissimilar to that shown in FIG. 3C. In this application, varnish 14 is applied in a pattern about the application area 28 and results in a substantial portion of the application area 28 being covered with varnish 14. Such may be desirable if the secondary label 16 to be applied to the shrink film 12 is small or less sizeable (in comparison to other types of secondary labels 16). For example, this varnish 14 application may be appropriate when the application area 28 to be covered with varnish 14 is substantial (e.g., if the size of the secondary label 16 is relatively large in comparison to article 18).

Referring now to FIGS. 4A-4C, the Figures show one embodiment of an secondary label 16 that could be pre-applied to a shrink film 12 to form the shrink sleeve label 10. Specifically, the Figures show a two-panel resealable extended content label 30. It is to be understood that the secondary label 16 of the label 10 could take on forms other than the depicted two-panel resealable extended content label 30. For example, the secondary label 16 could be a standard (pressure-sensitive) label (e.g., a “label violator”), a multi-layer extended content label (e.g., with multiple print panels that could be used for extended text information, regulatory information, information in another language, etc.), a removeable coupon (e.g., where a top ply is removeable and non-replaceable for use as a redeemable coupon), a game/play value piece, or an extended content removeable or resealable label (with one or more panels). Further, the secondary label 16 can take on forms other than those explicitly shown in FIGS. 4A-4C or listed here, as would be understood by one skilled in the art.

In FIG. 4A, the face 32 of the two-panel resealable extended content label 30 upon which content or label information (text, graphics, etc.) can be printed is shown. The label 30 may be made of film, paper, or another suitable material. The face 32 of the label 30 is covered by a clear laminant 34. The laminant 34 extends beyond the face 32 of the label 30 in at least one direction to form a permanent spine 36. The spine 36 adheres (e.g., by a permanent adhesive) to a surface 26 of the shrink film 12 to form a hinge 38. The combination of the spine 36 and hinge 38 features allow a customer to partially peel back the label 30 such that the content of the rear 40 of the label 30 can be observed. FIG. 4B shows the rear 40 of the two-panel resealable extended content label 30. Like the face 32 of the label 30, content or label information (text, graphics, etc.) can also be printed upon the rear 40 of the label 30. Such expands the printable area of the label 30 and thus the amount of content or label information that can be included on the label 30. The rear 40 of the label 30 may also include a releasable adhesive, for example, thereupon to aid in the resealing of the label 30. FIG. 4C shows the layered construction of the two-panel resealable extended content label 30. Further, the Figure illustrates how the label 30 is affixed to the shrink film 12.

Referring now to FIG. 5, the Figure shows a shrink sleeve label 10 prior to the label 10 being applied to an article 18. As shown in the Figure, the shrink sleeve label 10 includes a secondary label 16. The secondary label 16 has been applied to the shrink label 10 in the application area 28 of the varnish 14 (see FIG. 2-3C and the description thereof). To arrive at the form depicted in the Figure, the flat shrink film 12 of FIG. 2 has undergone a seaming process whereby the shrink film 12 is manipulated to form a cylindrical tube 42 shape and the lateral edges 24 of the shrink film 12 are joined together (e.g., by overlapping and gluing). The secondary label 16 is applied to the shrink film 12 during the seaming process in the application area 28 of the varnish 14. However, in alternative embodiments it is to be understood that the secondary label 16 could be applied to the shrink film 12 before or after the seaming process.

Applying the secondary label 16 to the shrink film 12 before applying the shrink sleeve label 10 to the article 18 improves the efficiency by which a customer can apply shrink sleeve labels 10 with secondary labels 16 to an article 18. In turn, this reduces a customer's costs and creates and/or improves customer application efficiency. Specifically, because the secondary label 16 is pre-applied to the shrink film 12 (e.g., applied prior to arriving to a customer who will apply the label 10 to an article 18), a customer does not need to spend time (and money) applying the secondary label 16 to the shrink film 12 after the shrink film 12 is applied to the article 18. What is an industry standard a two-step process (i.e., applying a shrink sleeve label to an article, then applying the secondary label to the shrink sleeve label on the article) becomes a one-step process for the customer—namely, applying the shrink sleeve label 10 (with the pre-applied secondary label 16) to the article 18. Thus, the efficiency of a customer's application process is improved and cost to apply the labels 10 to article 18 is decreased. Such pre-application of the secondary label 16 may also result is additional benefits not explicitly described herein, but would be recognized by one of skill in the art.

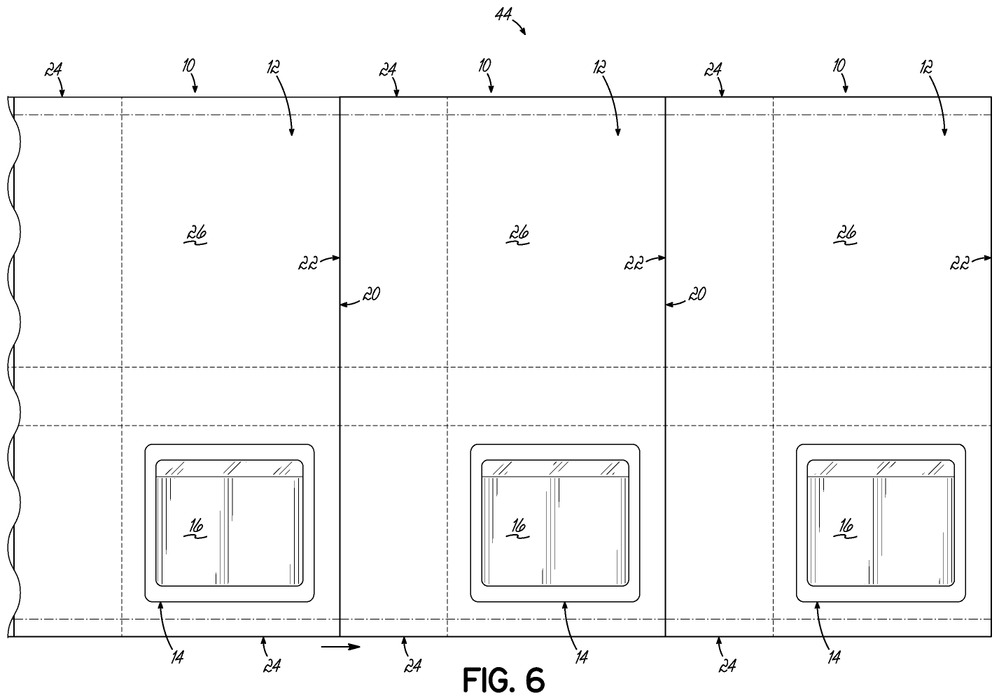

Referring now to FIG. 6, the Figure shows a series of shrink sleeve labels 10. Particularly, the Figure illustrates how a customer may arrange the shrink sleeve labels 10 into a sheet 44 prior to applying the labels 10 to articles 18. After the labels 10 go through the seaming process (as described above with respect to FIG. 5), the cylindrical, tube 42 shaped label 10 is laid flat into a roll format. Labels 10 may be provided (e.g., transported, shipped) to a customer in this roll format. To prepare the labels 10 for application, a customer could cut (e.g., guillotine cut) and sheet 44 the labels 10 (as depicted in the Figure) prior to applying the labels 10 to articles 18. Application of a label 10 to an article 18 is described in greater detail above with respect to FIG. 1.

While the present invention has been illustrated by the description of various embodiments and while these embodiments have been described in some detail, it is not the intention of the Applicant to restrict or in any way limit the scope of the invention to such detail. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A shrink sleeve label comprising:
an unshrunken shrink film;
a varnish applied to the shrink film in an application area, the varnish configured to reduce shrinking of the shrink film in the application area; and
a secondary label applied to a surface of the shrink film.

2. The shrink sleeve label of claim 1, wherein the secondary label is applied to the shrink film in the application area.

3. The shrink sleeve label of claim 1, wherein the application area is larger in at least one dimension than the secondary label.

4. The shrink sleeve label of claim 3, wherein the application area is larger in at least two dimensions than the secondary label.

5. The shrink sleeve label of claim 1, wherein the secondary label is a standard label.

6. The shrink sleeve label of claim 1, wherein the secondary label is a removable coupon label.

7. The shrink sleeve label of claim 1, wherein the secondary label is an extended content label.

8. The shrink sleeve label of claim 7, wherein the extended content label comprises multiple panels.

9. The shrink sleeve label of claim 7, wherein the extended content label is resealable.

10. The shrink sleeve label of claim 1, wherein the shrink film is clear.

11. The shrink sleeve label of claim 1, wherein the shrink film is non-clear.

12. A method of manufacturing a shrink sleeve label, the method comprising:
providing a shrink film;
seaming the shrink film into a tubular shape;
providing a secondary label; and
applying the secondary label to the shrink film,
wherein the secondary label is applied to the shrink film before the shrink film is applied to an article.

13. The method of manufacturing a shrink sleeve label of claim 12, the method further comprising:
applying a varnish to the shrink film in an application area, the varnish configured to prevent shrinking of the shrink film in the application area.

14. The method of manufacturing a shrink sleeve label of claim 13, wherein the varnish is applied to the shrink film before the shrink film is applied to the article.

15. The method of manufacturing a shrink sleeve label of claim 13, wherein the varnish is applied by solid spot sprint.

16. The method of manufacturing a shrink sleeve label of claim 13, wherein the varnish is applied by feathered edge spot print.

17. The method of manufacturing a shrink sleeve label of claim 13, wherein the varnish is applied by patterned spot print.

18. The method of manufacturing a shrink sleeve label of claim 12, wherein the secondary label is applied to the shrink film before the step of seaming.

19. The method of manufacturing a shrink sleeve label of claim 12, wherein the secondary label is applied to the shrink film during the step of seaming.

20. The method of manufacturing a shrink sleeve label of claim 12, wherein the secondary label is applied to the shrink film after the step of seaming.
